(19) United States
(12) Patent Application Publication
(10) Pub. No.: US 2010/0219310 A1
(43) Pub. Date: Sep. 2, 2010

(54) PLUMBING FIXTURE MOUNTING BRACKET ASSEMBLY

(76) Inventor: Max Stephen Rose, Arden, NC (US)

Correspondence Address: Russ Weinzimmer, 614 Nashua Street, Suite 53, Milford, NH, 03055, US

(21) Appl. No.: 12/489,421

(22) Filed: Jun. 22, 2009

Related U.S. Application Data
(60) Provisional application No. 61/208,068, filed on Feb. 20, 2009.

(51) Int. Cl. F16M 13/02

(52) U.S. Cl. 248/222.14; 248/224.8

(57) ABSTRACT

An adjustable mounting bracket assembly for a fixture is disclosed for securely mounting a fixture to construction framing and easily enabling adjustment of the depth of the fixture at any time during or after a wall installation process. A fixture mounting bracket assembly includes a mounting structure having a mounting plate and male connectors, and a support structure having a support frame and female connectors. The male and female connectors join the mounting structure and the support structure, providing an adjustable space between the mounting plate and the support frame. The respective connectors can engage with each other through various means, such as a simple peg and hole friction assembly, a screw and screw hole threaded assembly, a rivet and hole assembly, and/or a locking pin and hole array assembly. The bracket assembly is configured to support a fixture.

### CROSS-REFERENCE TO RELATED APPLICATIONS

This application claims the benefit of U.S. Provisional Patent Application No. 61/208,068, titled “Adjustable Mount for Securing Single Lever Valves inside a Wall,” filed Feb. 20, 2009, and incorporated herein by reference in its entirety.

### FIELD OF THE INVENTION

The invention generally relates to hardware, and more specifically to mounting brackets.

### BACKGROUND OF THE INVENTION

Plumbing valves, such as bathroom shower valves, are usually positioned between the studs in the framing of one wall of a room, such as a bathroom. Once a valve is installed and the studs are finished, the valve is then partially covered with an outer layer of tiles, plaster, or sheet rock. Bathroom fixtures are finally attached to the valves. The valves must be set at an exact depth with respect to the outer wall of tile, plaster, or sheet rock. This depth is generally determined by a tile installer, who is rarely on-site when the valve is installed. If this depth measurement is inaccurate, extreme measures, such as removing tile, must be undertaken to correct the problem.

### SUMMARY OF THE INVENTION

The present invention offers advantages over existing prior art by providing a fixture mounting bracket assembly for securely mounting a fixture, such as a shower valve, to construction framing, and easily enabling an adjustment of the fixture in or out at any time during an installation process as well as after a finish wall has been installed.

The invention features a fixture mounting bracket assembly, as well as a method of positioning a fixture to the bracket assembly. In its broadest embodiment, the bracket assembly comprises a mounting structure with male connectors and a support structure with female connectors, the mounting structure and support structure joined via the connectors, such that the depth of insertion of the male connectors into the female connectors is adjustable. The support structure can be mounted to a construction framing member, and a fixture can be mounted to the mounting structure.

The mounting structure includes a mounting plate and a set of male connectors, and the support structure includes a support frame and a set of female connectors. The female connectors are adapted to receive the male connectors in a fixed and adjustable depth, thereby joining the mounting structure and the support structure, and providing an adjustable space between the mounting plate and the support frame. The mounting structure is configured to accommodate a fixture, such as a plumbing fixture. In some preferred embodiments, the mounting plate includes a plurality of connector-receiving cavities adapted to receive the male connectors. In other preferred embodiments, the mounting plate does not include connector-receiving cavities, but the male connectors are integral to the mounting structure.

In preferred embodiments, the male connectors can be rods, bars or threaded bolts for example, and can be adapted to communicate with their corresponding female connectors via various possible arrangements, such as a peg and hole friction assembly, a screw and screw hole threaded assembly, a rivet and hole assembly, and/or a locking pin and hole array locking assembly. In some preferred embodiments, the mounting plate is fabricated from steel or plastic. The mounting plate can include a plurality of fixture-securing cavities, adapted to secure a fixture with clamping devices, such as U-bolts, hooks, and J-bolts. Alternatively, a fixture can be secured with screws or bolts, which can be inserted into already existing holes in some fixtures.

In some preferred embodiments, the support frame includes a pair of support-securing cavities adapted to receive attachment devices to secure the support structure to a framing member. The support structure can be secured to a construction framing member via such attachment devices as nails, screws, nuts and/or bolts.

Here we will recite the substance of all the claims, in more readable prose form.

### BRIEF DESCRIPTION OF THE DRAWINGS

The invention will be more fully understood by reference to the detailed description, in conjunction with the following figures, wherein:

FIG. 1 illustrates an isometric view of an exemplary plumbing fixture mounting bracket assembly.

FIG. 2 illustrates an isometric view of an exemplary rigid stabilizer bar.

FIG. 3 illustrates an isometric view of an exemplary plumbing fixture mounting bracket assembly with attached plumbing fixture.

FIG. 4 illustrates a cross-sectional view of an exemplary plumbing fixture mounting bracket assembly with attached plumbing fixture.

FIG. 5 illustrates a flow diagram.

### DETAILED DESCRIPTION OF PREFERRED EMBODIMENTS

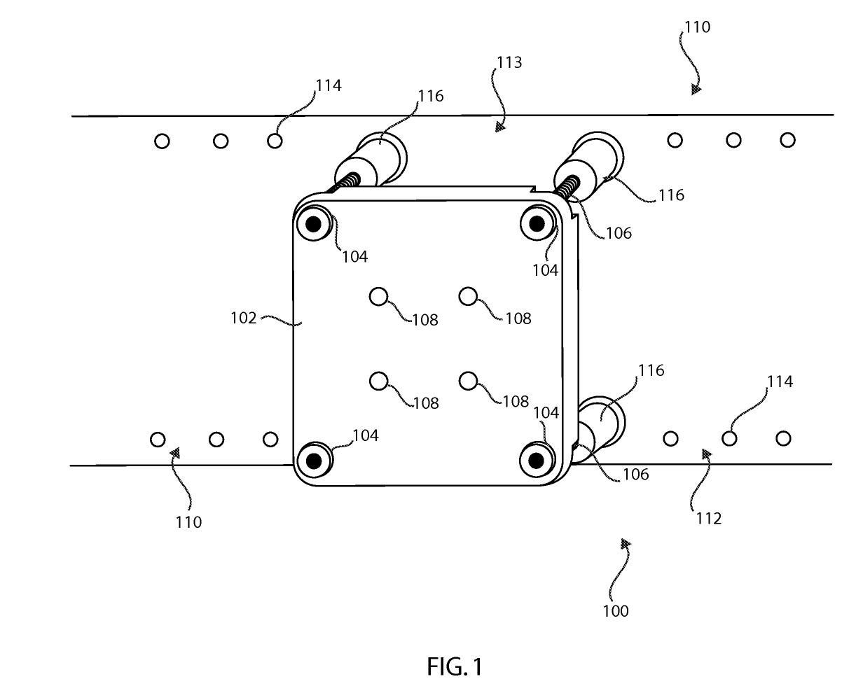

In its broadest embodiment, the fixture mounting bracket assembly 100 comprises a mounting structure and a support structure. The mounting structure includes a mounting plate 102 and at least one male connector 106. In FIG. 1, the mounting plate 102 is shown in a generally square shape. In other implementations, the mounting plate 102 can be designed in any shape that a particular application dictates, such as a rectangular shape, a circular shape, a triangular shape, and so forth. The mounting plate 102 can be fabricated with any one of several rigid materials, such as steel, plastic, and so forth, and in any thickness or depth.

In its broadest embodiment, the support structure includes a support frame 110 and at least one female connector 116. Each female connector 116 is adapted to receive each corresponding male connector 106 at a fixed and adjustable depth. The male and female connectors 106, 116 join the mounting structure and the support structure, providing an adjustable space between the mounting plate 102 and the support frame 110. In broad embodiments, the male and female connectors 106, 116 can engage with each other through various arrangements, such as a simple peg and hole friction assembly, a screw and screw hole threaded assembly, a rivet and hole assembly, and/or a locking pin and hole array assembly. In one implementation, the male connectors 106 are adjusted so that the mounting plate 102 is approximately parallel to a plane in which the supports 110 reside.

In the particular implementation shown, the mounting plate 102 includes a number of cavities. As shown in FIG. 1, in the preferred embodiment shown, a set of connector-receiving cavities 104 is positioned near the four corners of the mounting plate 102 and adapted to receive male connectors 106, such as rods, bars or threaded mounting bolts. In the preferred embodiment shown, the male connectors are threaded bolts. These male connectors 106 are permanently attached to the mounting plate 102 so that they can turn freely, but the mounting plate 102 will stay securely at the end of male connectors 106. In alternative embodiments, the male connectors 106 can be fixedly connected to the mounting plate 102, and inserted into the female connectors 116 at a desired depth via such arrangements as a simple peg and hole friction assembly, a rivet and hole assembly, and/or a locking pin and hole array assembly.

The mounting plate 102 can also include other cavities. A set of fixture-securing cavities 108 are shown in FIG. 1, adapted to secure a fixture with clamping devices, or with screws or bolts which can be inserted into existing mounting holes in some fixtures. For example, some shower valves include holes for being mounted to a mounting structure. In the particular embodiment shown, the mounting plate 102 can also include a set of fixture-securing cavities 108 for fixedly securing a plumbing fixture (not shown) to the mounting plate 102. More specifically, this set of fixture-securing cavities 108 can be used to secure a fixture with clamping devices such as U-bolts, hooks, J-bolts, and so forth, or with screws or bolts which are inserted into existing holes in the fixture to be secured to the bracket. In other implementations, a fixture is secured to the mounting plate by other means, such as soldering, without a need for the fixture-securing cavities 108.

In the particular implementation shown, the support structure of the bracket assembly 100 includes a support frame 110 and at least one female connector 116. In the embodiment shown, the support frame 110 is a support plate 110. The support plate 110 shown has support-securing cavities 114 lined across a bottom support portion 112, and support-securing cavities 114 lined across a top support portion 113. These support-securing cavities 114 are adapted to receive attachment devices to secure the support 110 to a framing member (not shown), such as wood studs. These support-securing cavities can also facilitate horizontal adjustment of the placement of the support plate 110. As shown in FIG. 1, the support plate 110 also includes two female connectors 116 placed across its upper edge and two female connectors placed across its lower edge. As shown in FIG. 1, the female connectors are threaded cylinders adapted to receive threaded bolt male connectors. The female connectors can also be blocks, or any other connectors adapted to receive corresponding male connectors. In other implementations, the support structure can be fabricated with holes to receive the male connectors 106 directly, without a need for cylinders, blocks, or the like.

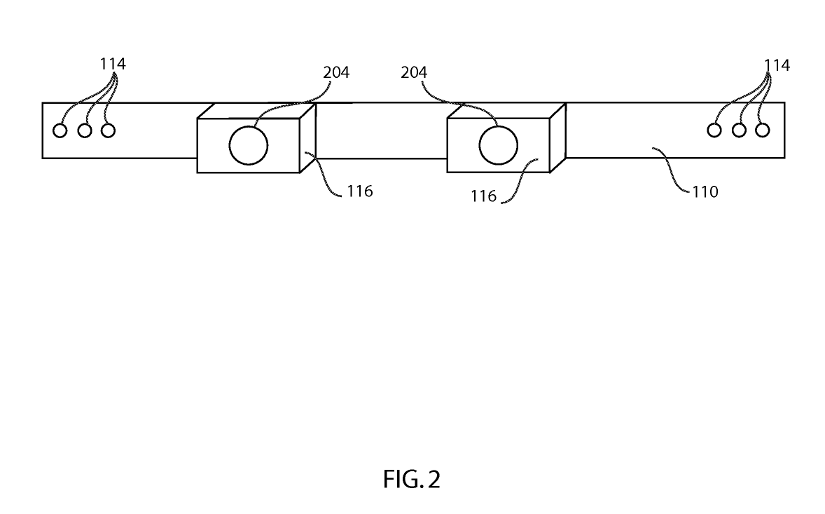

In some embodiments, the support frame can include a pair of rigid supports 110, 112 such as stabilizer bars 110, 112. Each of the support bars 110, 112 includes support-securing cavities 114 adapted to receive attachment devices to secure the supports 110, 112 to a framing member (not shown), such as wood studs. FIG. 2 shows an alternative embodiment of a support frame portion which is a stabilizer bar 112 which, along with a second stabilizer bar, makes up a support frame. As shown in FIG. 2, each of the supports 110, 112 includes support-securing cavities 114. Securing devices (not shown) can be used to affix each of the supports, 110, 112 through cavities 114, to a wood or metal frame. Example securing devices includes nails, screws, bolts, and so forth.

Each of the supports 110, 112 includes a pair of female connectors 116 for receiving the male connectors 106. As shown in FIG. 2, the female connectors 116 can be threaded blocks 116 adapted to receive threaded bolts. The female connectors 116 can also be cylinders, or any other connectors adapted to receive corresponding male connectors 106 in the manner described above. Once positioned in the blocks 116, the threaded bolts 106 can be adjusted to vary a position of the mounting plate 102 with respect to the blocks 116 and the support frame 110, 112. The blocks 116 are fabricated to adhere to the supports 110, 112 and they include connector-receiving cavities 204 to receive the male connectors 106. In other implementations, the supports 110, 112 are fabricated with holes to receive the male connectors 106 directly without a need for cylinders or blocks, or the like.

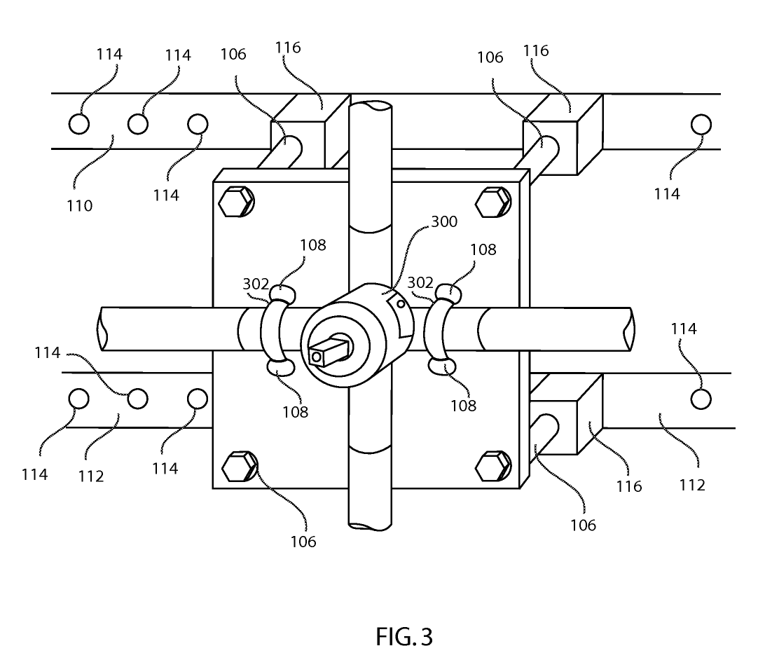

As shown in FIG. 3, an exemplary plumbing fixture 300 is attached to the mounting plate 102 with two U-clamps 302. Adjustment the male connectors 106 moves the plumbing fixture 300 on the mounting plate 102 with respect to a plane in which the pair of supports 110, 112 reside. In other implementations, the exemplary plumbing fixture 300 can be attached to the mounting plate 102 using other means, such as soldering, clamps, J-bolts, and so forth. In still other embodiments, screws or bolts can be inserted through the mounting plate, and directly into existing holes in the plumbing fixture.

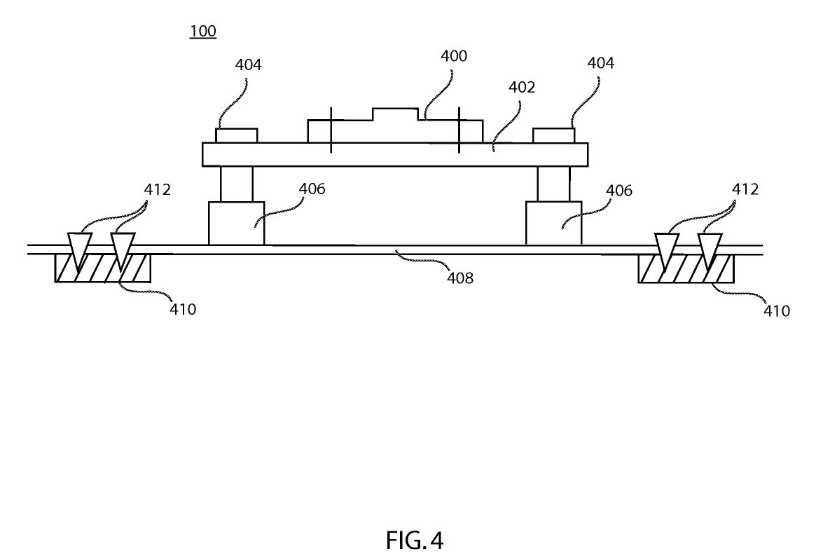

As shown in FIG. 4, a side view of the exemplary plumbing fixture mounting bracket assembly 100 includes a plumbing fixture 400 attached to a mounting plate 402. Male connectors 404, such as threaded bolts, pass through the mounting plate 402 into corresponding holes in blocks 406 attached to a rigid support 408. The rigid support 408 is attached to framing members 410 with securing devices 412. Rotating the male connectors 404 causes the mounting plate 402 and plumbing fixture 400 to move up and down with respect to the rigid support 408.

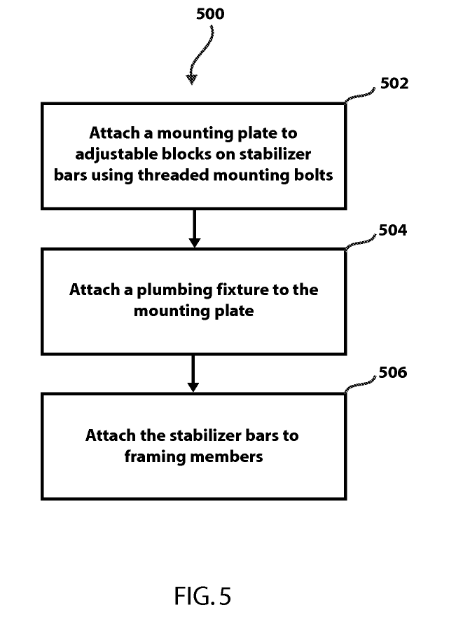

As shown in FIG. 5, a process 500 for variably positioning a fixture relative to a framing member, includes attaching (502) a mounting plate to female connectors on a support structure using male connectors, attaching (504) a fixture to the mounting plate, and attaching (506) the support structure to a framing member.

The mounting plate can be fabricated from steel, plastic, and so forth. The female connectors can include cavities. The female connectors can be blocks. The support structure can comprise a support plate, or alternatively can comprise a pair of stabilizer bars. The male connectors can be threaded bolts. The fixture to be mounted to the mounting plate can be a plumbing fixture, such as a shower valve for example.

Attaching (504) the mounting the plumbing fixture to the mounting plate includes securing the plumbing fixture to the mounting plate with clamping devices. The clamping devices can be U-bolts, hooks, J-bolts and so forth.

Attaching (506) the supports to framing members can include securing the supports to the framing members with nails or screws.

Other modifications and implementations will occur to those skilled in the art without departing from the spirit and the scope of the invention as claimed. Accordingly, the above description is not intended to limit the invention except as indicated in the following claims.

What is claimed is:

1. A fixture mounting bracket assembly, the bracket assembly comprising:
a mounting structure including a mounting plate and at least one male connector, the mounting structure being configured to accommodate a fixture; and
a support structure including a support frame and at least one female connector, the at least one female connector being adapted to receive the at least one male connector at a fixed and adjustable depth, thereby joining the mounting structure and the support structure, and providing an adjustable space between the mounting plate and the support frame.

2. The bracket assembly of claim 1, wherein the at least one male connector and corresponding at least one female connector are adapted to connect to each other via at least one of:
a peg and hole friction assembly;
a screw and screw hole threaded assembly;
a rivet and hole assembly; and
a locking pin and hole array assembly.

3. The bracket assembly of claim 1, wherein the support frame is a plate.

4. A plumbing fixture mounting bracket assembly, the bracket assembly comprising:
a mounting plate having a first plurality of cavities adapted to receive male connectors therethrough, the mounting plate configured to accommodate a fixture;
a support structure, the support structure having cavities adapted to receive attachment devices to secure the support to a framing member and a pair of blocks for receiving the male connectors; and
the male connectors permanently positioned through the first plurality of mounting plate cavities and into corresponding blocks to variably space apart and join the mounting plate to the blocks of the pair of supports.

5. The bracket assembly of claim 4, wherein the mounting plate is fabricated from at least one of steel and plastic.

6. The bracket assembly of claim 4, wherein the mounting plate is positioned approximately parallel to the pair of supports by rotating each of the male connectors.

7. The bracket assembly of claim 4, wherein the attachment devices are selected from the group consisting of nails, screws, nuts and bolts.

8. The bracket assembly of claim 4, wherein the mounting plate comprises a second plurality of cavities adapted to secure the fixture with connecting devices selected from the group consisting of screws, bolts, U-bolts, hooks and J-bolts.

9. The bracket assembly of claim 4, wherein the male connectors are selected from the group consisting of rods, bars and threaded bolts.

10. A plumbing fixture mounting bracket assembly, the bracket assembly comprising:
a mounting plate having a first plurality of cavities adapted to receive threaded mounting bolts and a second plurality of cavities for fixedly securing a plumbing fixture;
a pair of rigid stabilizer bars, each of the stabilizer bars having cavities adapted to attachment devices to secure the stabilizer bar to a framing member and a pair of threaded blocks for receiving the threaded mounting bolts; and
the threaded mounting bolts permanently positioned through the first plurality of mounting plate cavities and into corresponding threaded blocks to variably space apart and join the mounting plate to the threaded blocks of the pair of stabilizer bars.

11. The bracket assembly of claim 10, wherein the mounting plate is fabricated from at least one of steel and plastic.

12. The bracket assembly of claim 10, wherein the attachment devices are selected from the group consisting of nails, screws, nuts and bolts.

13. The bracket assembly of claim 10, wherein the second plurality of cavities for fixedly securing a plumbing fixture are sized to receive at least one of screws, bolts, and clamping bolts.

14. The bracket assembly of claim 13, wherein the clamping bolts are selected from the group consisting of U-bolts, hooks and J-bolts.

15. A method for variably positioning a fixture between framing members, the method comprising:
attaching a mounting plate to at least one female connector on a support structure using male connectors permanently attached to the mounting plate;
attaching a plumbing fixture to the mounting plate; and
attaching the support structure to a framing member.

16. The method of claim 15, wherein the mounting plate is fabricated from at least one of steel and plastic.

17. The method of claim 15, wherein the at least one female connector is a threaded block including cavities.

18. The method of claim 15, wherein attaching the mounting the fixture to the mounting plate comprises securing the fixture to the mounting plate with connecting devices.

19. The method of claim 18, wherein the connecting devices are selected from the group consisting of screws, bolts, U-bolts, hooks and J-bolts.

20. The method of claim 15, wherein attaching the support structure to the framing member comprises securing the support structure to the framing member with nails or screws.
